(19) United States
(12) Patent Application Publication
(10) Pub. No.: US 2018/0291820 A1
(43) Pub. Date: Oct. 11, 2018

(54) MALFUNCTION DETERMINATION FOR GAS TURBINE ENCLOSURE

(71) Applicant: General Electric Company, Schenectady, NY (US)

(72) Inventor: Hua Zhang, Greer, SC (US)

(21) Appl. No.: 15/479,595

(22) Filed: Apr. 5, 2017

(51) Int. Cl. F02C 9/48; F02C 7/12

(52) U.S. Cl. CPC F02C 9/48; F02C 7/12

(57) ABSTRACT

A method, system and program product for determining a malfunction in a gas turbine enclosure are disclosed. The method may include measuring a temperature at a plurality of locations relative to the gas turbine enclosure; determining a flow rate of a cooling gas through the gas turbine enclosure; and determining a malfunction in the gas turbine enclosure exists in response to at least one of the measured temperatures and the determined flow rate contradicting a model of gas turbine system operational parameters versus respective expected temperatures at the plurality of locations and an expected flow rate of the cooling gas through the gas turbine enclosure.

### BACKGROUND OF THE INVENTION

The disclosure relates generally to gas turbine systems, and more particularly, to determining malfunctions in a gas turbine enclosure.

Gas turbine systems are typically positioned within a gas turbine enclosure, the latter of which includes a ventilation system to remove heat from the gas turbine system in a controlled manner. The gas turbine enclosure typically includes a number of sections that are coupled by sealed flange connections. Malfunctions may occur within the gas turbine enclosure that are difficult to identify. For example, the sealed flange connections may begin to leak over time, or flow into or out of the gas turbine enclosure may decrease over time due to blockages. The malfunctions can increase temperature within the gas turbine enclosure, reducing the advantages of the enclosure's ventilation system. Identifying the existence of a malfunction is challenging because a gas turbine system may change output during operation and, hence, the thermal energy required to be removed by its gas turbine enclosure. Conventional gas turbine enclosures include simple alarm systems that indicate when a particular operational parameter, e.g., temperature or pressure, exceed a threshold, but the systems do not identify malfunctions in the gas turbine enclosures, i.e., the source of the issue, in relation to gas turbine operation.

### BRIEF DESCRIPTION OF THE INVENTION

A first aspect of the disclosure provides a method for determining a malfunction in a gas turbine enclosure, the system including: measuring a temperature at a plurality of locations relative to the gas turbine enclosure; determining a flow rate of a cooling gas through the gas turbine enclosure; and determining a malfunction in the gas turbine enclosure exists in response to at least one of the measured temperatures and the determined flow rate contradicting a model of gas turbine system operational parameters versus respective expected temperatures at the plurality of locations and an expected flow rate of the cooling gas through the gas turbine enclosure.

A second aspect of the disclosure provides a system for determining a malfunction in a gas turbine enclosure, the system including: a plurality of thermocouples measuring a temperature at a plurality of locations relative to the gas turbine enclosure; a flow rate determinator determining a flow rate of a cooling gas through the gas turbine enclosure; and a malfunction determinator determining a malfunction in the gas turbine enclosure exists in response to at least one of the measured temperatures and the determined flow rate contradicting a model of gas turbine system operational parameters versus respective expected temperatures at the plurality of locations and an expected flow rate of the cooling gas through the gas turbine enclosure.

A third aspect of the disclosure provides a program product stored on a non-transitory, computer readable medium for determining a malfunction in a gas turbine enclosure, the computer readable medium including program code for performing the following steps: measuring a temperature at a plurality of locations relative to the gas turbine enclosure; determining a flow rate of a cooling gas through the gas turbine enclosure; and determining a malfunction in the gas turbine enclosure exists in response to at least one of the measured temperatures and the determined flow rate contradicting a model of gas turbine system operational parameters versus respective expected temperatures at the plurality of locations and an expected flow rate of the cooling gas through the gas turbine enclosure.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a schematic illustration of an exemplary gas turbine system.

FIG. 2 shows a schematic illustration of a gas turbine enclosure according to embodiments of the disclosure.

FIG. 3 shows a block diagram of a gas turbine enclosure malfunction determination system according to embodiments of the disclosure.

FIG. 4 shows a flow diagram of an operational methodology of the system of FIG. 3 according to embodiments of the disclosure.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

As an initial matter, in order to clearly describe the current disclosure it will become necessary to select certain terminology when referring to and describing relevant machine components within a gas turbine system or gas turbine enclosure. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

As indicated above, the disclosure provides a gas turbine enclosure malfunction determination system, method and program product for a gas turbine enclosure.

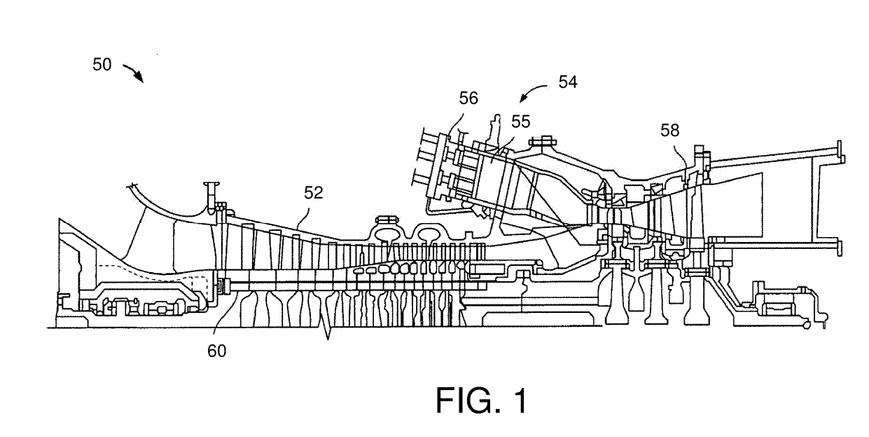

FIG. 1 shows a schematic illustration of an illustrative gas turbine (GT) system 50. GT system 50 includes a compressor 52 and a combustor 54. Combustor 54 includes a combustion region 55 and a fuel nozzle assembly 56. GT system 50 also includes a turbine 58 and a common compressor/turbine shaft 60 (sometimes referred to as rotor 60). In one embodiment, GT system 50 is a MS7001FB engine, sometimes referred to as a 9FB engine, commercially available from General Electric Company, Greenville, S.C. The present disclosure is not limited to any one particular engine and may be implanted in connection with other gas turbine systems.

In operation, air flows through compressor 52 and compressed air is supplied to combustor 54. Specifically, the compressed air is supplied to fuel nozzle assembly 56 that is integral to combustor 54. Fuel nozzle assembly 56 is in flow communication with combustion region 55. Fuel nozzle assembly 56 is also in flow communication with a fuel source (not shown in FIG. 1) and channels fuel and air to combustion region 55. Combustor 54 ignites and combusts fuel. Combustor 54 is in flow communication with turbine 58 for which gas stream thermal energy is converted to mechanical rotational energy. Turbine 58 is rotatably coupled to and drives rotor 60. Compressor 52 also is rotatably coupled to rotor 60. In the illustrative embodiment, there is a plurality of combustors 54 and fuel nozzle assemblies 56.

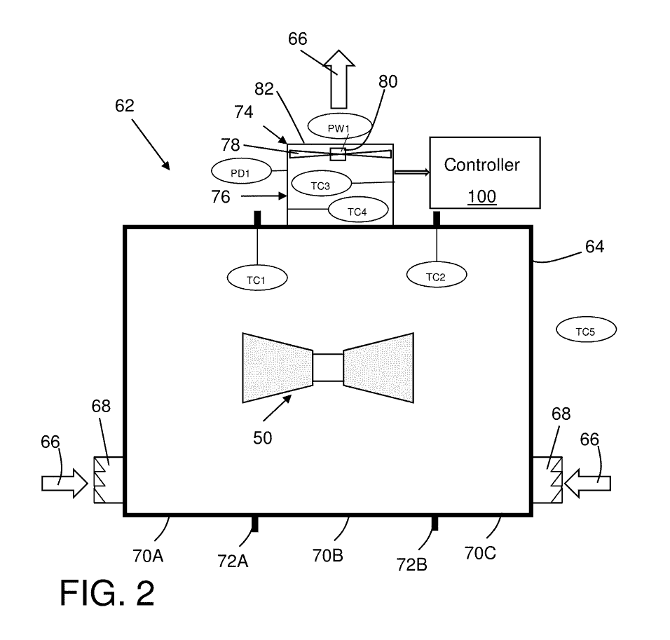

FIG. 2 shows a schematic block diagram of a gas turbine (GT) enclosure 62 including GT system 50 therein. GT enclosure 62 includes a housing 64 including one or more cooling gas 66 inlets 68 (two shown). Inlets 68 may include any now known or later developed inlet structures, e.g., louvres, filters, noise reduction systems, etc. Cooling gas 66 is typically air, but could include other gases. Housing 64 may include a number of sections 70A, B, C (three shown) coupled to together by sealed flange connections 72A, B (two shown). Note, flange connections 72A, B extend about each half-shell section of housing 64. As understood, housing 64 creates a sealed chamber about GT system 50. GT enclosure 62 may include a ventilation system 74 having a fan housing 76 positioning a fan 78 powered by a motor 80. Fan housing 76 is open to housing 64 such that fan 78 may draw cooling gas 66 through housing 64. Cooling gas 66 exhausts from fan housing 76.

GT enclosure 62 may further include a number of sensors including but not limited to: a number of temperature sensors TC1, TC2, TC3, TC4, a pressure sensor PD1, and a motor power meter PW1. Temperature sensors TC1-TC4 may include any now known or later developed temperature measurement sensors such as but not limited thermocouples, laser sensors and thermometers. In one embodiment, a plurality of temperature sensors may be positioned at a plurality of locations about GT enclosure 62 such that a temperature at a plurality of locations relative to GT enclosure 62 can be measured. In another embodiment, at least one of the plurality of locations include a flange connection 72A, 72B in GT enclosure 62. In another embodiment, the locations may include at least one location in an outlet duct (fan housing 76) of GT enclosure 62 (e.g., TC3, TC4), at least one location within GT enclosure 62 (e.g., TC1, TC2) and at least one location outside of GT enclosure 62 (e.g., TC5 in an area surrounding the enclosure). Temperature sensor TC5 at the outside location measures the ambient temperature which may provide a baseline of air temperature changes throughout GT enclosure 62. For locations within GT enclosure 62, a temperature sensor may be provided, for example, at each flange connection 72A, 72B, e.g., TC1, TC2, or other locations of potential leakage. Pressure sensor PD1 may include any form of pressure sensor. In one embodiment, pressure sensor PD1 measures a pressure differential between inlet 68 and an outlet 82 of fan housing 76. In another embodiment, PD1 may measure a fan pressure at outlet 82 of fan 78 that draws the cooling gas through GT enclosure 62. For clarity, only one pressure sensor PD1 is referenced and shown in FIG. 2. Motor power meter PW1 may include any form of electric meter capable of measuring a power usage of fan motor 80, e.g., by current, watts, etc.

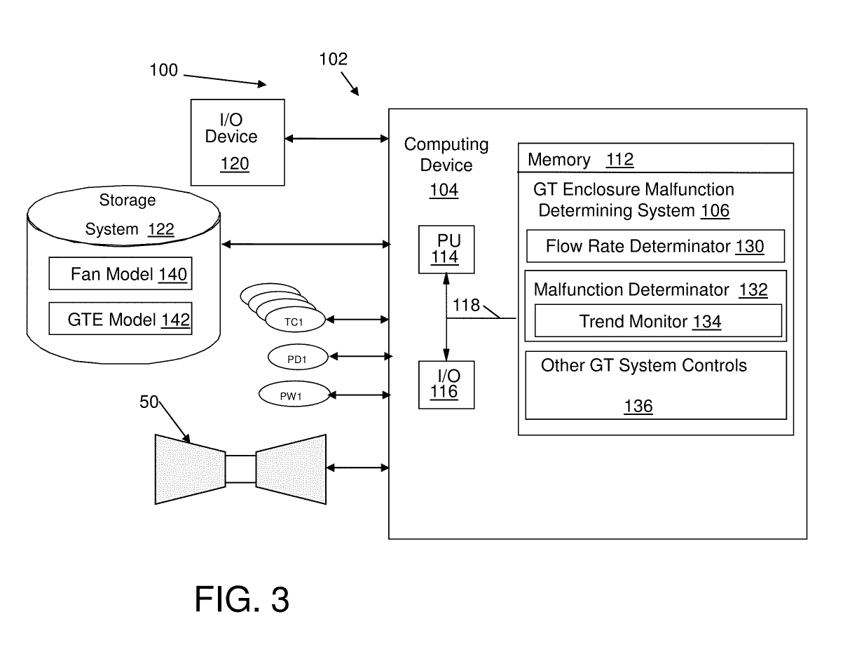

As shown in FIG. 2, GT enclosure 62 is operatively coupled to a controller 100 for malfunction determination in GT enclosure 62 according to embodiments of the disclosure. As will be recognized, controller 100 may be a separate system for providing GT enclosure 62 with malfunction determining according to embodiments of the disclosure alone, or it may be part of a larger control system for GT system 50. FIG. 3 shows an illustrative environment for controller 100. To this extent, the environment includes a computer infrastructure 102 that can perform the various process steps described herein for determining a malfunction of GT enclosure 62 (FIG. 2). In particular, computer infrastructure 102 is shown including a computing device 104 that comprises a GT enclosure malfunction determining system 106, which enables computing device 104 to determine a malfunction with GT enclosure 62 (FIG. 2) by performing the process steps of the disclosure.

Computing device 104 is shown including a memory 112, a processor (PU) 114, an input/output (I/O) interface 116, and a bus 118. Further, computing device 104 is shown in communication with an external I/O device/resource 120 and a storage system 122. As is known in the art, in general, processor 114 executes computer program code, such as GT enclosure malfunction determining system 106, that is stored in memory 112 and/or storage system 122. While executing computer program code, processor 114 can read and/or write data, such as GT enclosure malfunction determining system 106, to/from memory 112, storage system 122, and/or I/O interface 116. Bus 118 provides a communications link between each of the components in computing device 104. I/O device 120 can comprise any device that enables a user to interact with computing device 104 or any device that enables computing device 104 to communicate with one or more other computing devices. Input/output devices (including but not limited to keyboards, displays, pointing devices, etc.) can be coupled to the system either directly or through intervening I/O controllers. In addition, controller 100 receives data from a large number of sensors relative to GT enclosure 62 (FIG. 2) such as the previously described temperature sensors TC1-TC5, pressure sensor PD1 and motor power meter PW1, among others, and also may receive any now known or later developed GT system 50 operational parameters such as but not limited to: load, various operating temperatures such as an exhaust temperature, compressor temperature, and various operating pressures.

In any event, computing device 104 can comprise any general purpose computing article of manufacture capable of executing computer program code installed by a user (e.g., a personal computer, server, handheld device, etc.). However, it is understood that computing device 104 and GT enclosure malfunction determining system 106 are only representative of various possible equivalent computing devices that may perform the various process steps of the disclosure. To this extent, in other embodiments, computing device 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 102 is only illustrative of various types of computer infrastructures for implementing the disclosure. For example, in one embodiment, computer infrastructure 102 comprises two or more computing devices (e.g., a server cluster) that communicate over any type of wired and/or wireless communications link, such as a network, a shared memory, or the like, to perform the various process steps of the disclosure. When the communications link comprises a network, the network can comprise any combination of one or more types of networks (e.g., the Internet, a wide area network, a local area network, a virtual private network, etc.). Network adapters may also be coupled to the system to enable the data processing system to become coupled to other data processing systems or remote printers or storage devices through intervening private or public networks. Modems, cable modem and Ethernet cards are just a few of the currently available types of network adapters. Regardless, communications between the computing devices may utilize any combination of various types of transmission techniques.

As previously mentioned and discussed further below, GT enclosure malfunction determining system 106 enables computing infrastructure 102 to determine a malfunction within GT enclosure 62 (FIG. 2). To this extent, GT enclosure malfunction determining system 106 is shown including a number of modules that provide the various functions thereof. The modules may include, for example, a flow rate determinator 130, a malfunction determinator 132 including in one embodiment a trend monitor 134, and other GT system controls 136. Other GT system controls 136 may include any now known or later developed GT system 50 controls as may be found in a standalone GT system controller. Modules may also include conventional over-temperature alert systems to alert users of temperatures at specified locations exceeding respective levels. Operation of each system and module presented according to embodiments of the disclosure are discussed further below. However, it is understood that some of the various modules and systems shown in FIG. 3 can be implemented independently, combined, and/or stored in memory for one or more separate computing devices that are included in computer infrastructure 102. Further, it is understood that some of the modules, systems and/or functionality may not be implemented, or additional systems and/or functionality may be included as part of environment 100.

As will be appreciated by one skilled in the art, the present disclosure may be embodied as a system, method or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

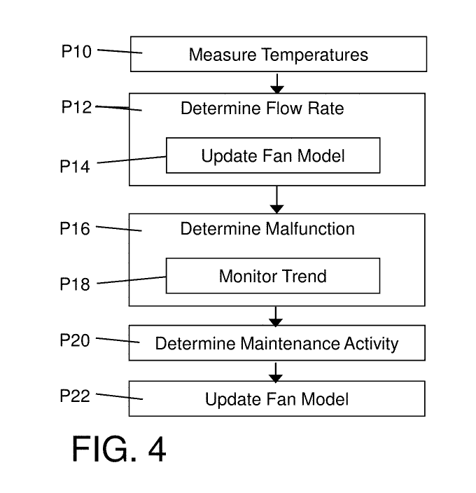

FIG. 4 shows a flow diagram illustrating embodiments of a method of operation of controller 100 and GT enclosure malfunction determining system 106. With reference to FIGS. 2-4 collectively, embodiments of a method of operation of controller 100 and GT enclosure malfunction determining system 106 will now be described. In process P10, temperature sensors, e.g., TC1-TC5, measure a temperature at a plurality of locations relative to GT enclosure 62. For example, as previously described, the locations may include at least one location in an outlet duct (fan housing 76) of GT enclosure 62 (e.g., TC3, TC4), at least one location within GT enclosure 62 (e.g., TC1, TC2) and at least one location outside of GT enclosure 62 (e.g., TC5 in an area surrounding the enclosure). For locations within GT enclosure 62, a temperature sensor may be provided, for example, at each flange connection 72A, 72B, e.g., TC1, TC2, or other locations of potential leakage. Controller 100 and GT enclosure malfunction system 106 receive the measurements.

In process P12, flow rate determinator 130 (FIG. 3) determines a flow rate of cooling gas 66 through GT enclosure 62. Flow rate determinator 130 may calculate a flow rate in a number of ways. In one embodiment, flow rate determinator 130 may determine the flow rate of cooling gas 66 (FIG. 2) by the following process. First, it may measure a fan pressure P_{F} at outlet 82 of fan 78 that draws cooling gas 66 through GT enclosure, e.g., receive a fan pressure P_{F} from fan pressure sensor PD1. As noted, pressure sensor PD1 may include any form of pressure sensor. In one embodiment, pressure sensor PD1 may measure a fan pressure P_{F} at outlet 82 of fan 78 that draws cooling gas 66 through GT enclosure 62. In another embodiment, pressure sensor PD1 measures a pressure differential between inlet 68 of fan 78 (of GT enclosure 62) and outlet 82 of fan 78, i.e. of fan housing 76. Either measurement may be employed with minor variations in the process. Second, flow rate determinator 130 may measure a fan motor 80 power draw of fan 78, e.g., receive power draw from fan power draw meter PW1. As noted, fan motor power meter PW1 may include any form of electric meter capable of measuring a power usage of fan motor 80, e.g., by current, watts, etc. Finally, flow rate determinator 130 may determine the flow rate from a fan model 140 that correlates fan pressure P_{F} and fan motor power draw to a flow rate. Fan model 140 is shown stored in storage system 122 in FIG. 3, and may also be referred to as a ‘fan curve’. In any event, each fan 78 may have a correlation between a fan pressure P_{F} it can create and the fan motor power that it draws that has a direct relation to the flow rate it can generate for a given GT enclosure 62. In another embodiment, fan model 140 may also further correlate cooling gas 66 temperature to flow rate. In this case, process P12 may include measuring a cooling gas temperature (e.g., at a desired location within GT enclosure 62 using a dedicated cooling gas thermocouple or one of the aforementioned temperature sensors). In this case, flow rate determinator 130 may determine the flow rate using fan model 140 that further correlates the cooling gas temperature to the flow rate, along with fan pressure and fan motor power draw. In either case, fan model 140 can be known for a given GT enclosure 62 with a given fan 78, or may be calculated based on empirical data measured over time. In an optional process P14, flow rate determinator 130 may update fan model 140 based on accumulated operating hours of GT enclosure 62. For example, it may be known or otherwise measured that a flow rate of fan 78 decreases by a certain amount per 1000 hours of operation. Once GT enclosure 62 attains that number of hours of operation, fan model 140 can be updated to accommodate that adjustment. The factors that may impact the update vary widely and include but are not limited to: wear of fan 78, material build up in inlet(s) 68, and GT system 50 load and/or age.

In process P16, malfunction determinator 132 determines a malfunction in GT enclosure 62 exists in response to at least one of the measured temperatures and the determined flow rate contradicting a model 142 of gas turbine system operational parameters versus respective expected temperatures at the plurality of locations and an expected flow rate of cooling gas 66 through GT enclosure 62. Model 142 may be referred to herein as a gas turbine enclosure (GTE) model 142 to differentiate from fan model 140, and is shown stored in storage system 122 in FIG. 2. GTE model 142 may be based on a computational fluid dynamics (CFD) study of GT enclosure 62. Alternatively, GTE model 142 can be based on empirical data. In any event, GTE model 142 correlates GT system 50 operational parameters, which are received by controller 100 from GT system 50, such as load, versus expected temperatures at the plurality of locations and expected flow rate of cooling gas 66 through GT enclosure 62. For example, for a GT system 50 operating at a known load, e.g., 65%, GTE model 142 may be expected to have a temperature of, for example, 800° C., at temperature sensor TC1 at flange connection 72A. When the temperature is different, e.g., higher, than the rest of the plurality of locations at which temperatures are measured, malfunction determinator 132 may indicate a leakage malfunction exists at the location of flange connection 72A. That is, malfunction determinator 132 may indicate a leak at flange connection 72A, which is causing the temperature to rise. In another example, malfunction determinator 132 may indicate a leakage malfunction when the flow rate of cooling gas 66 through GT enclosure 62 changes, e.g., by a certain amount that cannot be attributed to changes in GT system 50 operation. In another embodiment, as will be described herein, GTE model 142 may further include a correlation between temperatures at the plurality of locations, as measured by, for example, temperature sensors TC1-TC4, and the fan flow rate with a maintenance schedule.

In an optional process P18, a trend monitor 134 (perhaps part of malfunction determinator 132) monitors a trend in the temperature at each of the plurality of locations (e.g., at each temperature sensor TC1-TC4), and may determine a leakage malfunction exists at a first location in response to a change in a trend in the temperature at the first location. For example, where GT system 50 is operating at a steady state load, and a particular temperature sensor TC2 suddenly shows a change in temperature, malfunction determinator 132 may indicate a leak exists at the location of temperature sensor TC2.

In another optional process P20, GTE model 142 may further include a correlation between temperatures at the plurality of locations, as measured by temperature sensors TC1-TC4, and the fan flow rate with a maintenance schedule. For example, where certain temperature sensors TC3, TC4 are measuring higher than expected temperatures and a fan flow rate is lower than expected, malfunction determinator 132 may determine a maintenance activity is required based on GTE model 142. That is, GTE model 142 may indicate in certain special circumstances that a malfunction exists, but it is simply a need for maintenance. The maintenance activity can be any now known or later developed activity conducted relative to GT enclosures 62 such as but not limited to: lubricating fan 78 and/or motor 80, a cleaning of inlets 68, cleaning of fan housing 76, inlet filter (not shown) replacement and/or sensor replacements.

Embodiment of the disclosure also include GT enclosure malfunction determining system 106. As described herein, system 106 includes plurality of temperature sensors TC1-TC5 measuring a temperature at a plurality of locations relative to GT enclosure 62. System 106 further may include flow rate determinator 130 determining a flow rate of cooling gas 66 through GT enclosure 62. As noted herein, flow rate determinator 130 may include fan pressure sensor PD1 measuring a fan pressure at an outlet of a fan that draws the cooling gas through the gas turbine enclosure, and a fan motor power meter PW1 measuring a fan motor power draw of the fan. System 106 may also include malfunction determinator 132 determining a malfunction in GT enclosure 62 per the methods described herein. In an optional embodiment, system 106 may also include trend monitor 134 monitoring a trend in the temperature at each of the plurality of locations,

Embodiments of the disclosure provide a technical effect by allowing for determination of, among other forms of malfunctions, inlet 68 louver blockage, GT flange connection 72A, 72B leakage, and fan 78 and/or motor 80 issues. Embodiments of the disclosure thus allow corrections to be made to, for example, GT enclosure 62, ventilation system 74 thereof and/or GT system 50, all of which may increase overall power plant efficiency, and protect GT system 50 components and systems.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A method for determining a malfunction in a gas turbine enclosure, the system comprising:
measuring a temperature at a plurality of locations relative to the gas turbine enclosure;
determining a flow rate of a cooling gas through the gas turbine enclosure; and
determining a malfunction in the gas turbine enclosure exists in response to at least one of the measured temperatures and the determined flow rate contradicting a model of gas turbine system operational parameters versus respective expected temperatures at the plurality of locations and an expected flow rate of the cooling gas through the gas turbine enclosure.

2. The method of claim 1, further comprising:
monitoring a trend in the temperature at each of the plurality of locations,
wherein determining the malfunction further includes determining a leakage malfunction exists at a first location in response to a change in a trend in the temperature at the first location.

3. The method of claim 1, wherein determining the malfunction includes determining a leakage malfunction exists at a first location of the plurality of locations in response to: a) the first location having a difference in temperature compared to a rest of the plurality of locations, and b) a change in the flow rate of the cooling gas through the gas turbine enclosure.

4. The method of claim 1, wherein the model further includes a correlation between the temperatures at the plurality of locations and the fan flow rate with a maintenance schedule, and further comprising determining a maintenance activity is required based on the model.

5. The method of claim 1, wherein the model is based on a computational fluid dynamics (CFD) study of the gas turbine enclosure.

6. The method of claim 1, wherein determining the flow rate of the cooling gas includes:
measuring a fan pressure at an outlet of a fan that draws the cooling gas through the gas turbine enclosure;
measuring a fan motor power draw of the fan; and
determining the flow rate from a fan model that correlates the fan pressure and the fan motor power draw to a flow rate.

7. The method of claim 6, wherein the fan pressure measuring includes measuring a pressure differential between an inlet of the fan and an outlet of the fan.

8. The method of claim 6, further comprising measuring a cooling gas temperature, and wherein the determining the flow rate includes using the fan model that further correlates the cooling gas temperature to the flow rate.

9. The method of claim 6, further comprising updating the fan model based on accumulated operating hours of the gas turbine enclosure.

10. The method of claim 1, wherein the plurality of locations includes: at least one location in an outlet duct of the gas turbine enclosure, at least one location within the gas turbine enclosure and at least one location outside of the gas turbine enclosure.

11. A system for determining a malfunction in a gas turbine enclosure, the system comprising:
a plurality of thermocouples measuring a temperature at a plurality of locations relative to the gas turbine enclosure;
a flow rate determinator determining a flow rate of a cooling gas through the gas turbine enclosure; and
a malfunction determinator determining a malfunction in the gas turbine enclosure exists in response to at least one of the measured temperatures and the determined flow rate contradicting a model of gas turbine system operational parameters versus respective expected temperatures at the plurality of locations and an expected flow rate of the cooling gas through the gas turbine enclosure.

12. The system of claim 11, further comprising:
a trend monitor monitoring a trend in the temperature at each of the plurality of locations,
wherein malfunction determinator determines a leakage malfunction exists at a first location in response to a change in a trend in the temperature at the first location.

13. The system of claim 11, wherein the malfunction determinator determines a leakage malfunction exists at a first location of the plurality of locations in response to: a) the first location having a difference in temperature compared to a rest of the plurality of locations, and b) a change in the flow rate of the cooling gas through the gas turbine enclosure.

14. The system of claim 11, wherein at least one of the plurality of locations is at a flange connection in the gas turbine enclosure.

15. The system of claim 11, wherein the model further includes a correlation between the temperatures at the plurality of locations and the fan flow rate with a maintenance schedule, and further comprising a maintenance determinator determining a maintenance activity is required based on the model.

16. The system of claim 11, wherein the model is based on a computational fluid dynamics (CFD) study of the gas turbine enclosure.

17. The system of claim 11, wherein the flow rate determinator includes:
a fan pressure sensor measuring a fan pressure at an outlet of a fan that draws the cooling gas through the gas turbine enclosure; and
a fan motor power meter measuring a fan motor power draw of the fan,
wherein the flow rate determinator determines the flow rate from a fan model that correlates the fan pressure and the fan motor power draw to a flow rate.

18. The system of claim 17, further comprising a cooling gas thermocouple for measuring a cooling gas temperature, and wherein the flow rate determinator determines the flow rate using the fan model that further correlates the cooling gas temperature to the flow rate.

19. The system of claim 11, wherein the plurality of locations includes: at least one location in an outlet duct of the gas turbine enclosure, at least one location within the gas turbine enclosure and at least one location outside of the gas turbine enclosure.

20. A program product stored on a non-transitory, computer readable medium for determining a malfunction in a gas turbine enclosure, the computer readable medium comprising program code for performing the following steps:
measuring a temperature at a plurality of locations relative to the gas turbine enclosure;
determining a flow rate of a cooling gas through the gas turbine enclosure; and
determining a malfunction in the gas turbine enclosure exists in response to at least one of the measured temperatures and the determined flow rate contradicting a model of gas turbine system operational parameters versus respective expected temperatures at the plurality of locations and an expected flow rate of the cooling gas through the gas turbine enclosure.
